(19) United States
(12) Patent Application Publication
(10) Pub. No.: US 2026/0274116 A1
(43) Pub. Date: Sep. 17, 2026

(54) Seat Swivel Assembly for Vehicle

(71) Applicant: Daechang Seat Co., LTD - Dongtan, Hwaseong-si (KR)

(72) Inventors: Chan Ki Cho, Pyeongchang-gun (KR); Gun Young Park, Yongin-si (KR); Kyoung Jae Lee, Hwaseong-si (KR); Jeon Il Kang, Cheonan-si (KR); Jae Kwang Shin, Hwaseong-si (KR)

(21) Appl. No.: 19/560,686

(22) Filed: Mar. 9, 2026

(30) Foreign Application Priority Data
Mar. 11, 2025 (KR) 10-2025-0031519

(51) Int. Cl. B60N 2/14

(52) U.S. Cl. CPC B60N 2/14

(57) ABSTRACT

Proposed is a seat swivel assembly for a vehicle, which assists in maintaining concentric rotation, thereby enabling stable rotation. The assembly includes a support plate having a support plate center hole formed therein, an upper plate whose lower surface is in rolling contact with an upper surface of the support plate so as to rotate about an axis of the support plate center hole, a lower plate whose upper surface is in rolling contact with a lower surface of the support plate so as to rotate about the axis of the support plate center hole, and whose inner side is joined to an inner side of the upper plate, and a rolling guide disposed between the support plate and the lower plate, the rolling guide having a rolling portion formed to guide the lower plate to rotate concentrically relative to the axis of the support plate center hole.

### CROSS REFERENCE TO RELATED APPLICATION

The present application claims priority to Korean Patent Application No. 10-2025-0031519, filed Mar. 11, 2025, the entire contents of which is incorporated herein for all purposes by this reference.

### BACKGROUND

### Technical Field

The present disclosure relates to a seat swivel assembly for a vehicle.

### DESCRIPTION OF THE RELATED ART

In general, a seat swivel assembly is installed between the seat mechanism, such as the seat cushion, and a vehicle’s floor, or between the seat mechanism and seat tracks (or rails/sliders), and allows a seat to rotate by approximately 180 degrees. The seat swivel assembly is typically installed in passenger vehicles equipped with three or more seat rows. Seat swivels are classified into two primary types: power-operated seat swivels and manual seat swivels, with the primary difference being the method of rotation. Power swivels use an electric motor for automatic rotation, while manual swivels rely on the user’s physical force. To enhance user convenience, power-operated seat swivels are widely used.

Korean Patent No. 10-2435303 discloses a swivel apparatus.

The swivel apparatus disclosed in the above Patent Document consists of: an upper plate in which a rib flange is formed on an outer lower portion of a hollow part thereof and to which a ring gear is coupled, the ring gear having a through-hole formed therein so as to communicate with the hollow part; a middle plate disposed below the upper plate in a spaced-apart manner and having a hollow portion formed therein; a lower plate disposed below the middle plate in a spaced-apart manner and coupled to the upper plate through the hollow portion while partially intersecting with the middle plate; a first bearing part formed in a ring shape, disposed between the upper plate and the middle plate, and having a rib groove into which the rib flange is inserted; a second bearing portion disposed between the middle plate and the lower plate; and a drive part provided with a first bracket coupled to the lower edge of the middle plate, a motor coupled to the first bracket, and a drive shaft protruding upward from the motor to engage with the ring gear.

The above-described swivel apparatus relies solely on bearing parts installed between the upper plate, middle plate, and lower plate to achieve rotational movement. Under the load of a seated occupant, swiveling can cause the upper plate and lower plate to tilt slightly, resulting in misalignment and a loss of concentricity. This misalignment prevents smooth rotation and gives rise to various issues, including vibration and noise.

### Document of Related Art

(Patent Document 1) Korean Patent No. 10-2435303 (Registered August 18, 2022)

### SUMMARY

Accordingly, the present disclosure has been made keeping in mind the above problems occurring in the related art, and the present disclosure is intended to provide a seat swivel assembly for a vehicle, which assists in maintaining concentric rotation, thereby enabling stable rotation.

In order to achieve the above objective, according to an embodiment of the present disclosure, there is provided a seat swivel assembly for a vehicle, the assembly including: a support plate having a support plate center hole formed therein; an upper plate whose lower surface is in rolling contact with an upper surface of the support plate so as to rotate about an axis of the support plate center hole; a lower plate whose upper surface is in rolling contact with a lower surface of the support plate so as to rotate about the axis of the support plate center hole, and whose inner side is joined to an inner side of the upper plate; and a rolling guide disposed between the support plate and the lower plate, the rolling guide having a rolling portion formed to guide the lower plate to rotate concentrically relative to the axis of the support plate center hole.

In addition, the support plate of the assembly according to an embodiment may include: a support plate center portion in which the support plate center hole is formed; a support plate rib portion extending downward along a periphery of the support plate center portion; and a fixing plate portion extending outward from the support plate rib portion.

In addition, the lower plate of the assembly according to an embodiment may include: a lower plate center portion having an inner side coupled to the inner side of the upper plate; a first extension plate portion extending outward from the lower plate center portion, an upper surface of the first extension plate portion being in rolling contact with a lower surface of the support plate center portion so as to rotate about the axis of the support plate center hole; a lower plate rib portion extending downward from a periphery of the first extension plate portion while facing the support plate rib portion; and a second extension plate portion extending outward from the lower plate rib portion while facing the fixing plate portion.

In addition, the rolling guide of the assembly according to an embodiment may include: a guide rib portion disposed between the support plate rib portion and the lower plate rib portion; a rolling portion protruding from the guide rib portion toward the support plate rib portion; and a horizontal plate portion extending from the guide rib portion and positioned between the fixing plate portion and the second extension plate portion.

In addition, the rolling guide of the assembly according to an embodiment may further include: an auxiliary rolling portion protruding toward the support plate at a junction of the guide rib portion and the horizontal plate portion.

In addition, the horizontal plate portion of the assembly according to an embodiment may be spaced apart from the fixing plate portion and may be in contact with the second extension plate portion.

In addition, the rolling guide of the assembly according to an embodiment may include a plurality of rolling guides being spaced apart along a periphery of the lower plate.

In addition, the rolling guide of the assembly according to an embodiment may have a ring shape and may be provided along a periphery of the lower plate.

The seat swivel assembly for a vehicle according to an embodiment includes a rolling guide that supports and guides the support plate rib and the lower plate rib in the horizontal direction, and a ball retainer that supports and guides the upper plate and the support plate, as well as the support plate and the lower plate, in the vertical direction. As a result, the rotational center of the upper plate and lower plate can be maintained more stably during rotation.

Furthermore, the seat swivel assembly for a vehicle according to an embodiment can rotate concentrically, reducing vibration and noise, which in turn improves the operational smoothness.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view of a seat swivel assembly for a vehicle according to an embodiment;

FIG. 2 is an exploded view of a seat swivel assembly for a vehicle according to an embodiment;

FIG. 3 is a perspective view of a rolling guide according to an embodiment; and

FIG. 4 is a cross-sectional view taken along line A-A′ of FIG. 1.

### DETAILED DESCRIPTION

The advantages and features of the present disclosure, as well as the methods for achieving them, will become apparent from the following detailed description of embodiments taken in conjunction with the accompanying drawings. However, the present disclosure is not limited to the embodiments set forth herein and may be implemented in a variety of alternative forms. The embodiments described herein are provided to fully disclose the present disclosure and to enable those skilled in the art to understand the full scope of the present disclosure, and the present disclosure is defined solely by the scope of the claims. Throughout the specification, like reference numerals refer to like components.

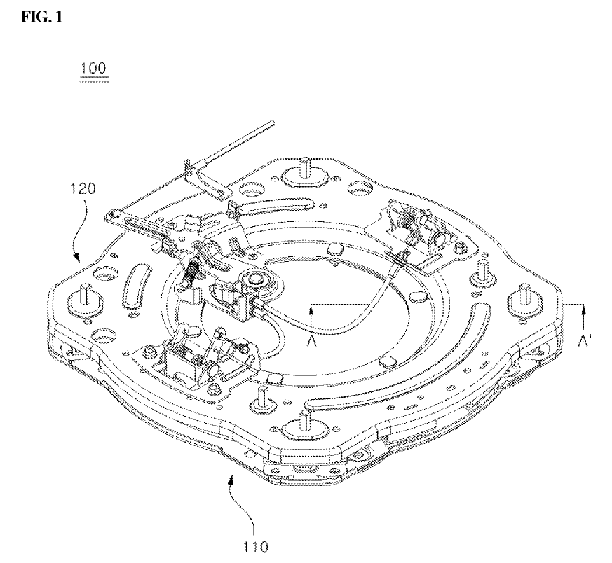

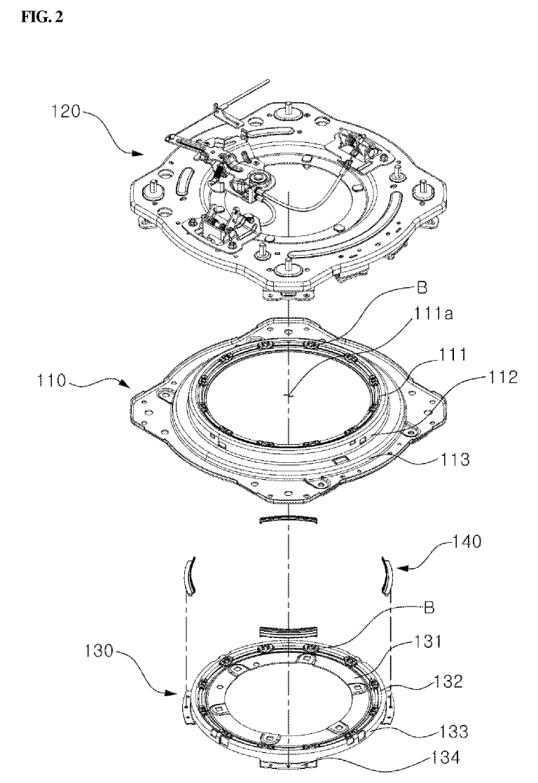

Referring to FIG. 1, which is a perspective view of a seat swivel assembly 100 for a vehicle [hereinafter referred to as the “vehicle seat swivel assembly 100”], and FIG. 2, which is an exploded view of the seat swivel assembly 100 for a vehicle according to an embodiment, the vehicle seat swivel assembly 100 includes a support plate 110, an upper plate 120, a lower plate 130, and a rolling guide 140.

The support plate 110 has a support plate center hole 111a formed at the center thereof and may be fixed to a vehicle (not shown).

As an example, the support plate 110 may include a support plate center portion 111, a support plate rib portion 112, and a fixing plate portion 113.

The support plate center portion 111 has a plate shape and is provided with the support plate center hole 111a at the center thereof.

The support plate rib portion 112 extends downward along the periphery of the support plate center portion 111. The support plate rib portion 112 increases the rigidity of the support plate 110.

The fixing plate portion 113 extends outward from the support plate rib portion 112 and is fixed to a vehicle.

The upper plate 120 is rotatably disposed about the axis of the support plate center hole 111a and rolls on the upper surface of the support plate 110. In addition, a center hole may be formed at the center of the upper plate 120, and the upper plate 120 may be in rolling contact with the support plate 110 via a ball retainer B. At this time, the clearance can be adjusted by controlling the angle of the ball retainer B, which contacts the support plate center portion 111 and a portion of the upper plate 120. A larger angle of the ball retainer B is advantageous for vertical clearance, whereas a smaller angle is advantageous for horizontal clearance. In the present specification, an example is provided in which the angle of the ball retainer B is 65 degrees.

The lower plate 130 is rotatably disposed about the axis of the support plate center hole 111a and is in rolling contact with the lower surface of the support plate 110. In addition, the inner portion of the lower plate 130 is coupled to the inner portion of the upper plate 120 so that the lower plate 130 rotates together with the upper plate 120.

As an example, the lower plate 130 may include a lower plate center portion 131, a first extension plate portion 132, a lower plate rib portion 133, and a second extension plate portion 134.

The lower plate center portion 131 has a plate shape and may be provided with a lower plate center hole at the center thereof. In addition, the inner portion of the lower plate center portion 131 is coupled to the inner portion of the upper plate 120 so that the lower plate 130 rotates together with the upper plate 120.

The first extension plate portion 132 extends outward from the lower plate center portion 131, and the upper surface thereof is in rolling contact with the lower surface of the support plate center portion 111 so as to rotate about the axis of the support plate center hole 111a. The first extension plate portion 132 may be in rolling contact with the support plate center portion 111 via a ball retainer B. At this time, the clearance can be adjusted by controlling the angle of the ball retainer B, which contacts the support plate center portion 111 and first extension plate portion 132. A larger angle of the ball retainer B is advantageous for vertical clearance, whereas a smaller angle is advantageous for horizontal clearance. In the present specification, an example is provided in which the angle of the ball retainer B is 65 degrees.

The lower plate rib portion 133 extends downward from the periphery of the first extension plate portion 132, facing the support plate rib portion 112. The lower plate rib portion 133 increases the rigidity of the lower plate 130.

The second extension plate portion 134 extends outward from the lower plate rib portion 133, facing the fixing plate portion 113.

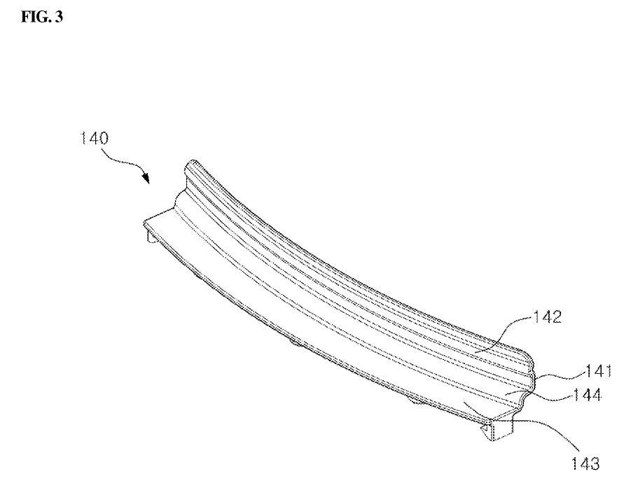

Referring to FIG. 3, which is a perspective view of the rolling guide 140, the rolling guide 140 is installed between the support plate 110 and the lower plate 130 and includes a rolling portion 142 that guides the lower plate 130 to rotate concentrically relative to the axis of the support plate center hole 111a.

As an example, the rolling guide 140 may include a guide rib portion 141, the rolling portion 142, and a horizontal plate portion 143.

The guide rib portion 141 is positioned between the support plate rib portion 112 and the lower plate rib portion 133.

The rolling portion 142 protrudes from the guide rib portion 141 toward the support plate rib portion 112 and contacts the support plate rib portion 112.

The horizontal plate portion 143 extends outward from the guide rib portion 141. For example, the horizontal plate portion 143 may extend from the guide rib portion 141 and be positioned between the fixing plate portion 113 and the second extension plate portion 134.

In addition, the horizontal plate portion 143 may be spaced apart from the fixing plate portion 113 and in contact with the second extension plate portion 134. As a result, during assembly of the vehicle seat swivel assembly 100, even if the ball retainer B overlaps the support plate center portion 111 and the first extension plate portion 132, causing the second extension plate portion 134 to spread, the horizontal plate portion 143 coupled to the second extension plate portion 134 remains spaced apart from the fixing plate portion 113. This prevents unnecessary surface contact between the fixing plate portion 113 and the horizontal plate portion 143. That is, the position of the support plate 110 and the rolling guide 140 may be adjusted, thereby reducing unnecessary friction between the support plate 110 and the rolling guide 140, which prevents interference with rotation.

In addition, a plurality of horizontal plate portions 143 may be provided spaced apart along the periphery of the lower plate 130. That is, a plurality of rolling guides 140 may be provided spaced apart along the periphery of the lower plate 130.

In addition, the horizontal plate portion 143 may have a ring shape and be formed along the periphery of the lower plate 130. That is, the rolling guide 140 may be ring-shaped and coupled along the periphery of the lower plate 130.

In addition, the rolling guide 140 may further include an auxiliary rolling portion 144.

The auxiliary rolling portion 144 protrudes toward the support plate 110 at a junction of the guide rib portion 141 and the horizontal plate portion 143. For example, the auxiliary rolling portion 144 may protrude at the connection between the guide rib portion 141 and the horizontal plate portion 143 toward the connection between the support plate rib portion 112 and the fixing plate portion 113. The auxiliary rolling portion 144 performs the same function as the rolling portion 142.

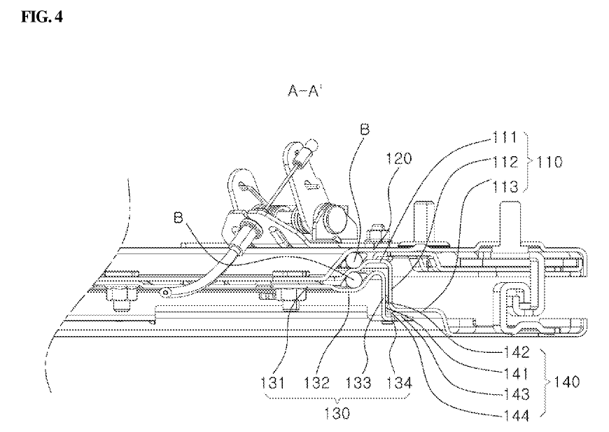

Referring to FIG. 4, a cross-sectional view taken along line A-A′ of FIG. 1, the coupling relationship of the vehicle seat swivel assembly 100 will be described in detail.

The support plate 110 is fixed to the vehicle by means of the fixing plate portion 113, and the support plate center hole 111a is formed in the support plate center portion 111.

The inner portion of the upper plate 120 is coupled to the inner portion of the lower plate 130, and the upper plate 120 and the lower plate 130 are in rolling contact with the upper and lower surfaces of the support plate center portion 111 via the ball retainers B, allowing the upper plate 120 and the lower plate 130 to rotate together about the axis of the support plate center hole 111a. At this time, in the case of the ball retainer B positioned between the upper plate 120 and the support plate center portion 111, the upper-left side of each ball contacts the upper plate 120, while the lower and lower-right sides of the ball contact the support plate center portion 111, providing three-point support. In addition, for the ball retainer B positioned between the support plate center portion 111 and the first extension plate portion 132, the upper and upper-left sides of each ball contact the support plate center portion 111, while the lower-right side of the ball contacts the first extension plate portion 132, providing three-point support.

Between the support plate 110 and the lower plate 130, the rolling guide 140 is provided to assist the concentric rotation of the upper plate 120 and the lower plate 130. To be specific, the concentric rotation of the upper plate 120 and the lower plate 130 is assisted by the rolling portion 142, which contacts the support plate rib portion 112, and the auxiliary rolling portion 144, which contacts the portion where the support plate rib portion 112 and the fixing plate portion 113 are connected.

The expressions (terms, visualized images, etc.) used to describe the embodiments of the present disclosure are merely selected for the purpose of facilitating understanding of the technology.

Furthermore, due to practical constraints, the present disclosure has been described with a limited number of embodiments, and those of ordinary skill in the art would be able to conceive new embodiments based on the described embodiments without departing from the technical spirit of the present disclosure.

Therefore, the claims of the present disclosure should not be construed as being limited by the specific expressions appearing in the “Description of the Invention” or the “Drawings”, but should be broadly interpreted based on the inherent technical concept of the disclosure as a whole.

What is claimed is:

1. A seat swivel assembly for a vehicle, the assembly comprising:
a support plate having a support plate center hole formed therein;
an upper plate whose lower surface is in rolling contact with an upper surface of the support plate so as to rotate about an axis of the support plate center hole;
a lower plate whose upper surface is in rolling contact with a lower surface of the support plate so as to rotate about the axis of the support plate center hole, and whose inner side is joined to an inner side of the upper plate; and
a rolling guide disposed between the support plate and the lower plate, the rolling guide having a rolling portion formed to guide the lower plate to rotate concentrically relative to the axis of the support plate center hole.

2. The assembly of claim 1, wherein the support plate comprises:
a support plate center portion in which the support plate center hole is formed;
a support plate rib portion extending downward along a periphery of the support plate center portion; and
a fixing plate portion extending outward from the support plate rib portion, and
the lower plate comprises:
a lower plate center portion having an inner side coupled to the inner side of the upper plate;
a first extension plate portion extending outward from the lower plate center portion, an upper surface of the first extension plate portion being in rolling contact with a lower surface of the support plate center portion so as to rotate about the axis of the support plate center hole;
a lower plate rib portion extending downward from a periphery of the first extension plate portion while facing the support plate rib portion; and
a second extension plate portion extending outward from the lower plate rib portion while facing the fixing plate portion.

3. The assembly of claim 2, wherein the rolling guide comprises:
a guide rib portion disposed between the support plate rib portion and the lower plate rib portion;
a rolling portion protruding from the guide rib portion toward the support plate rib portion; and
a horizontal plate portion extending from the guide rib portion and positioned between the fixing plate portion and the second extension plate portion.

4. The assembly of claim 3, wherein the rolling guide further comprises:
an auxiliary rolling portion protruding toward the support plate at a junction of the guide rib portion and the horizontal plate portion.

5. The assembly of claim 3, wherein the horizontal plate portion is spaced apart from the fixing plate portion and in contact with the second extension plate portion.

6. The assembly of claim 1, wherein the rolling guide includes a plurality of rolling guides being spaced apart along a periphery of the lower plate.

7. The assembly of claim 1, wherein the rolling guide has a ring shape and is provided along a periphery of the lower plate.
